(19) United States
(12) Patent Application Publication
(10) Pub. No.: US 2022/0318935 A1
(43) Pub. Date: Oct. 6, 2022

(54) SYSTEMS AND METHODS FOR REAL ESTATE TRANSACTIONS

(71) Applicant: Basil Starr, Beverly Hills, CA (US)

(72) Inventor: Basil Starr, Beverly Hills, CA (US)

(21) Appl. No.: 17/675,940

(22) Filed: Feb. 18, 2022

Related U.S. Application Data
(60) Provisional application No. 63/168,935, filed on Mar. 31, 2021.

(51) Int. Cl. G06Q 50/16

(52) U.S. Cl. CPC G06Q 50/16

(57) ABSTRACT

Some embodiments relate to systems and methods for real estate transactions. The system includes at least one database and a sales module. The sales module is configured to cause to be displayed a list of available modular homes for purchase from the at least one database. Additionally, the sales module is configured to receive at least one specification of a first modular home available for purchase from the list of available modular homes. The sales module is also configured to determine available land for purchase from the at least one database based on the at least one specification of the first modular home. The system includes a notification module configured to automatically notify a user when land becomes available that matches the at least one specification of the first modular home.

### CLAIM OF PRIORITY UNDER 35 U.S.C. § 119

The present application for patent claims priority to Provisional Application No. 63/168,935, entitled “SYSTEMS AND METHODS FOR REAL ESTATE TRANSACTIONS,” filed Mar. 31, 2021, and assigned to the assignee hereof and hereby expressly incorporated by reference herein.

### TECHNICAL FIELD

The disclosure relates generally to the field of real estate, specifically and not by way of limitation, some embodiments are related to computing systems for real estate transactions.

### BACKGROUND OF THE INVENTION

Currently, people cannot easily buy a modular home without first identifying and purchasing the land on which the modular home will be located. With current business models, there is no easy way for buyers to secure the purchase of a modular home from a modular home builder without first purchasing the land for the modular home. This is primarily because land purchases provide builders with an inherent transactional security by lowering the risk of cancellation. Moreover, current business models do not enable buyers to secure a modular home in advance. As a result, a buyers' ability to purchase their dream modular home without having first pre-purchased land is severely limited.

Consequently, there is a need for a platform that enables buyers to design and pre-purchase their dream modular home before purchasing land. A platform that enables buyers to separately purchase modular homes and land dramatically improves the liquidity of the real estate market.

### SUMMARY OF THE INVENTION

Provided herein are embodiments of systems for real estate transactions. Some embodiments notify a user when land becomes available that matches at least one specification of a first modular home.

Some embodiments relate to a system for real estate transactions. The system includes at least one database and a sales module. The sales module is configured to cause to be displayed a list of available modular homes for purchase from the at least one database. The sales module is configured to receive at least one specification of a first modular home available for purchase from the list of available modular homes. The sales module is also configured to determine available land for purchase from the at least one database based on the at least one specification of the first modular home. The system includes a notification module configured to automatically notify a user when land becomes available that matches the at least one specification of the first modular home.

Some embodiments relate to a method for real estate transactions. The method includes causing a list of available modular homes for purchase from at least one database to be displayed. The method also includes receiving at least one specification of a first modular home available for purchase from the list of available modular homes. Additionally, the method includes determining available land for purchase from the at least one database based on the at least one specification of the first modular home. The method also includes notifying a user when land becomes available that matches the at least one specification of the first modular home automatically.

Some embodiments relate to a computer program product for real estate transactions. The computer program product for real estate transactions includes a non-transitory computer-readable medium including code for causing a list of available modular homes for purchase from at least one database to be displayed. Additionally, the computer program product for real estate transactions includes a non-transitory computer-readable medium including code for receiving at least one specification of a first modular home available for purchase from the list of available modular homes. The computer program product for real estate transactions also includes a non-transitory computer-readable medium including code for determining available land for purchase from the at least one database based on the at least one specification of the first modular home. The computer program product for real estate transactions includes a non-transitory computer-readable medium including code for notifying a user when land becomes available that matches the at least one specification of the first modular home automatically.

### BRIEF DESCRIPTION OF THE DRAWINGS

The present invention may be better understood by referring to the following figures. The components in the figures are not necessarily to scale. Emphasis instead being placed upon illustrating the principles of the disclosure. In the figures, reference numerals designate corresponding parts throughout the different views.

FIG. 1 illustrates a block diagram of a system for modular homes transactions in accordance with some embodiments of the present disclosure.

FIG. 2 illustrates a modular home purchasing workflow in accordance with some embodiments of the present disclosure.

FIG. 3 illustrates an interactive real estate purchasing workflow in accordance with some embodiments of the present disclosure.

FIG. 4 illustrates a block diagram for the purchase of land and virtual real estate in accordance with some of embodiment of the present disclosure

FIG. 5 illustrates a workflow for the purchase of land and virtual real estate in accordance with some embodiments of the present disclosure.

FIG. 6 is a flowchart illustrating an example method for real estate transactions in accordance with some embodiments of the present disclosure.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In an aspect, a method of transacting that combines modular home sales, land sales, virtual real estate sales, and blockchain based assets into a single platform that unlocks value for buyers and sellers is disclosed. Historically, home sales have been inseparable from land sales. Using the systems and methods described herein, home buyers have the ability to select both the home and the land upon which the home may be built. Another aspect is the application of blockchain and virtual reality (VR) technology. An aspect uses VR technology to provide buyers with a new way to enjoy their homes and uses blockchain technology to introduce homebuyers to a new asset class.

In an aspect, a first layer may be a marketplace for modular homes. Modular homes, especially those developed using breakthroughs in 3D printing, may unlock tremendous savings in materials and labor cost. Further efficiencies may be unlocked in the marketplace described herein because the systems and methods described herein may separate modular home purchases from land purchases. Users may select the modular home the purchaser wishes to purchase, and then may be granted access to land available for sale. Our proprietary matching algorithms factor in land dimensions, user preferences, and other metadata when matching a modular home to available land plots upon which the home can be constructed. In other words, users may be empowered to select both their ideal home and their ideal location as opposed to the current normal in which users have to compromise on both.

In an aspect, a second layer may be the creation of blockchain assets. For each completed home purchase or home prepayment on the platform, the platform may create a 3D representation (e.g., digital twin) of the asset along with a unique piece of digital art. The unique piece of digital art and the 3D representation of the home may both be formatted as non-fungible tokens. (NFTs). In recent months, artistic NFTs have skyrocketed in popularity. The artistic NFTs may offer artists a new way to measure the popularity of the artist's creations and offer buyers a new way to store value. For this platform, artistic NFTs may serve as both a store of value and as a proof of membership in a community of successful, forward-thinking individuals who are committed to the future of real estate.

In an aspect, a third layer may include a marketplace for virtual land. Virtual worlds, dubbed metaverses by the media, have become areas of intense innovation over the last five years. What separates metaverses from popular digital worlds like Second Life, The Sims, and IMVU is that metaverses may be more fully immersive. Consequently, the interactions that take place in the metaverse may be likely to be more valuable. An aspect may use software integrations with metaverses that enable users to select and purchase virtual land in any and/or all of the metaverses that have partnered with the platform.

In an aspect, a fourth layer of the invention may harness Blockchain technology to simplify real estate transactions. Upon completion of the home's construction, the platform may automatically create a legal holding company that has title to the home. Ownership of the holding company may be conferred by ownership of a non-fungible-token (NFT) that automatically stores a record of transactions. This NFT may create value for homeowners by accelerating the buying and selling process. Instead of having to go through a time-consuming legal process, homeowners may sell partial or total ownership in the NFT representing a stake in the holding company.

Currently, people cannot easily buy a modular home without first identifying and purchasing the land on which the modular home will be located. With current business models, there is no easy way for buyers to secure the purchase of a modular home from a modular home builder without first purchasing the land for the modular home. This is primarily because land purchases provide builders with an inherent transactional security by lowering the risk of cancellation. Moreover, current business models do not enable buyers to secure a modular home in advance. As a result, buyers' ability to purchase their dream modular home without having first pre-purchased land is severely limited.

Consequently, there is a need for a business model or platform that enables buyers to design and pre-purchase their dream modular home before purchasing land. A platform that enables buyers to separately purchase modular homes and land dramatically improves the liquidity of the real estate market. Two additional innovations that further improve the liquidity of the market are non-fungible tokens (NFT's) and virtual real estate. Recent innovations in blockchain technology enable real estate to be purchased and sold quickly and securely via NFTs. Recent advances in virtual reality technology have pushed the concept of the metaverse, a fully immersive virtual reality environment, into the center of public imagination. As remote work and remote play become more mainstream, virtual real estate has the potential to improve the liquidity of the real estate market by providing buyers with more ways to enjoy their homes. The disclosed systems and methods (herein after “the platform”) provide transactional security to multiple stakeholders: modular home buyers, modular home builders, land sellers, and metaverse platforms by automatically minting NFTs and facilitating the purchase of both real and virtual land after the modular home is purchased.

The platform provides transactional security by pooling various resources (e.g., builders, buyers, developers, land, NFTs, metaverse platforms) together onto a single platform. This enables buyers to easily browse through available modular home models for purchase and also to identify potential land for the modular home. Even if a buyer cannot immediately identify land for purchase, the buyer can still secure a modular home and the platform will automatically mint an NFT, provide options for purchasing land in the metaverse, and inform the buyer when a plot of land in the real world that meets the buyer's preferences becomes available. The platform can include databases of developers, available land on metaverse platforms, and plots of land in development in the real world. The platform is configured to continuously query these databases for updates and to automatically inform the buyer of new land that fits the buyer's preferences when it becomes available. In this way, the buyer does not have to continuously do research, search across metaverses, contact developers and reach out to municipalities about potential land developments. By pooling resources and performing continuous updates and queries for the buyer, the platform greatly increases the success rate of buyers in identifying and securing land upon which to build a modular home.

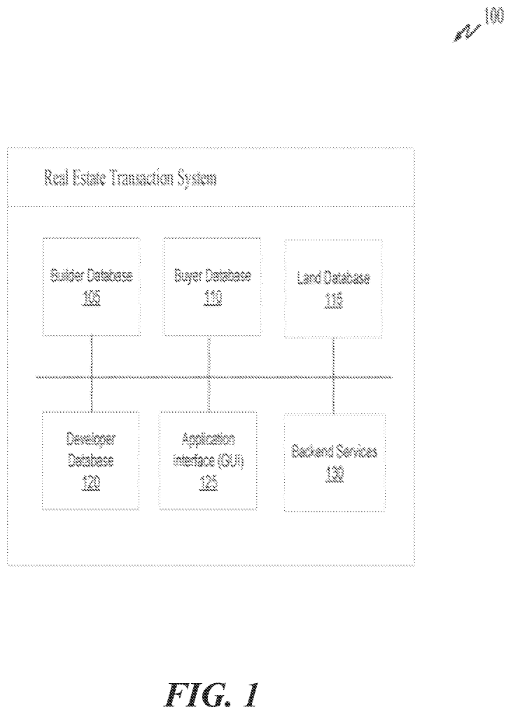

FIG. 1 illustrates a real estate transaction system 100 in accordance with some embodiments of the present disclosure. System 100 includes a builder database 105, buyer database 110, land database 115, developer database 120, metaverse land database 125, a database of NFTs minted on the platform 130, application interface or (GUI) module 135, and backend services module 140. Builder database 105 can include modular home builders that have been vetted and approved to meet customer service and quality standards. Buyer database 110 can include potential home buyers and institutional real estate investors. Land database 115 can include information on existing and future land availability. Database 115 can also have land data such as, but not limited to, lot size, market price, asking price, elevation, shape, zoning, ownership, and the same information on adjacent lots. Developer database 120 can include data on land developers. This enables the platform to work with developers to continuously update one or more of the databases in system 100. The metaverse land database 125 may be enabled via API integrations with participating metaverse platforms. The user may access the database in the platform and does not have to visit each metaverse individually. The NFT database may be a record of all of the NFTs that were automatically minted after purchases and prepayments. In an aspect, a 3D rendering of a home informed by data processed by the rendering module is minted into an NFT. In an example, minting may utilize software to create a non-fungible-token on a blockchain representing a unique 3D rendering. In an example, the software may be third party software.

GUI module 135 can include one or more interactive windows to show builders, modular homes available for design and order, real land, a 3D NFT rendering of a purchased modular home, and virtual land. GUI module 125 may also be configured to request and record various information from the buyer such as, but not limited to, modular home preferences (e.g., size, number of rooms, number of bathrooms, level, build material, roof, amenities, shape), land preferences (e.g., lot size, price range, shape, geographical location), and builder preferences.

GUI module 135, in conjunction with backend module 130, can display land available for sale and render the land to scale based on the land information such as lot size, elevational changes, and shape. GUI module 135 can also render a selected modular home (to scale) onto the rendered selected land using the modular home information such as, but not limited to, footprint and shape.

Backend services module 140 can include graphic rendering engines, notification services, database queries and update services, etc. Module 140 can be configured to continuously query land database 115 and developer database 120 to find land that matches one or more of the buyer's preferences (e.g., geographical location, price, lot size, location within the development, geographical features). Once a potential match is found, module 140 can automatically send a notification to the buyer via email or SMS. Module 140 can also cause GUI 135 to display a notification and a link to the land (for rendering) when the buyer logs into the system.

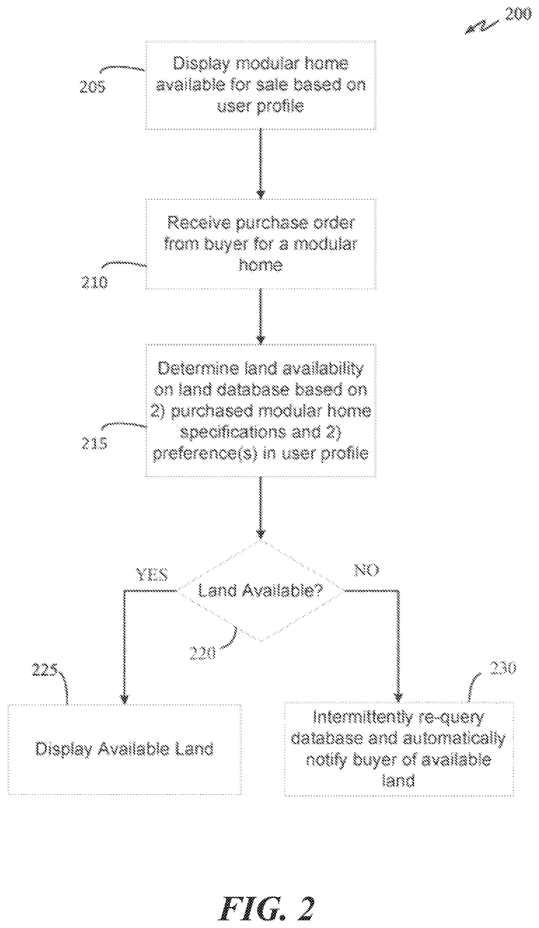

FIG. 2 illustrates a flow chart of a purchasing process 200 in accordance with some embodiments of the present disclosure. Process 200 starts at 205 where a list of available modular homes is displayed (by GUI module 140) to the buyer. For example, a list may be generated from information stored in a database and caused to be displayed on a screen or monitor. The list of available modular homes can be sorted and/or truncated by one or more preferences such as builder, price range, size range, number of bathrooms, number of bedrooms, etc.

At 210, a purchase order for a modular home is received. For example, the purchase order for a modular home may be received by scanning the purchase order to convert it to an electronic copy, or the purchase order may be received electronically. Accordingly, the electronic version of the purchase order (received electronically or scanned) may be received by a computing system implementing the systems and methods described herein. The systems and methods described herein may include communication channels to receive an electronic communication including the purchase order. At this point, system 200 can store all of the buyer's design choices and information related to the modular home. For example, system 200 can store the following information (but not limited to) of the purchased modular home: model number, builder information, exterior wall material(s) (e.g., aluminum sidings, stucco, brick panel), roof material(s), shape, size, and footprint.

At 215, system 200 determines the available land based at least on 1) specification of the purchased modular home, and/or 2) buyer's preferences such as lot size, shape, location, or other pertinent information. For example, system 200 may determine the available land based accessing a database listing parcels of land and determining which parcels are for sale in the database.

At 220, if there are lands that match one or more of the above preferences, the available lands are displayed to the buyer at 225. For example, the results from 215 may be written to a display device or otherwise displayed by a display of a computer, mobile telephone handset, or other electronic device. When there is no available land for purchase, system 200 can intermittently (e.g., daily, weekly) re-query one or more of the databases (e.g., land and developer databases) to check for availability based on the buyer's preferences and/or a land that would match one or more specifications (e.g., footprint) of the purchased modular home. When a match is found, system 200 can automatically send a notification to the buyer via email, text, or a phone call at 230. For example, a text message, email, voice mail, voice message, or other automated message me be caused to be sent based on determining that a match has been found. The text message, email, voice mail, voice message, or other automated message may include information on the property or properties found. In another example embodiment, the text message, email, voice mail, voice message, or other automated message may only include the information that a property has been located. Information on the property or properties found may be transmitted or viewed separately.

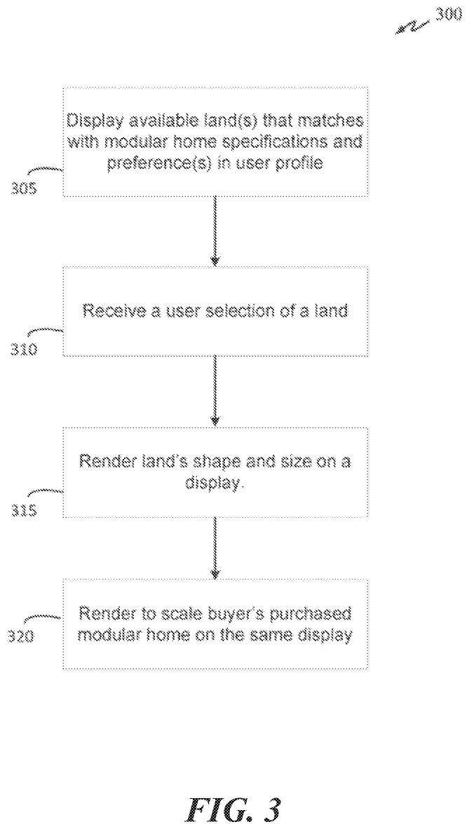

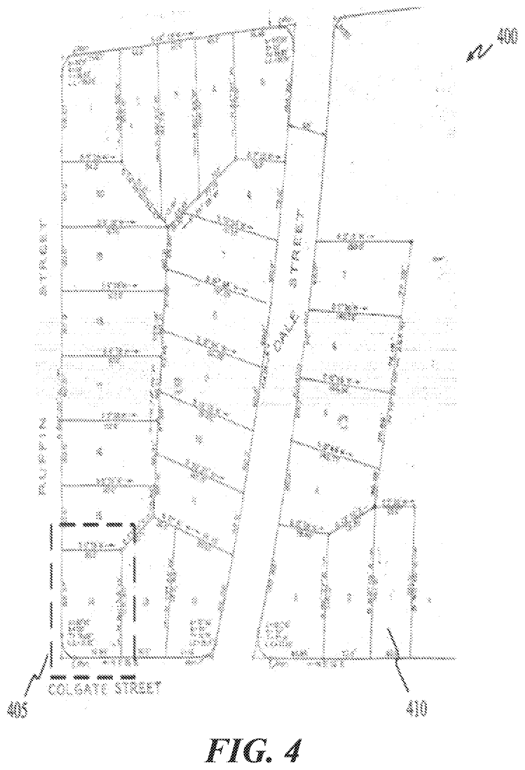

FIG. 3 is a flow chart of a rendering process 300 of system 200 in accordance with some embodiments of the present disclosure. Process 300 starts at 305 where available lands that match the buyer's preference (e.g., price, location) and/or modular home specification (e.g., footprint, shape) are displayed, e.g., by generating a list and causing the list to be displayed on a monitor or other display device. In an example, a modular home with a large circular footprint, e.g., relative to the lot size, would not fit well in a narrow and long rectangular lot, e.g., narrow relative to the large circular footprint. In this specific example, sub-process 305 can eliminate any small and narrow rectangular lot from the list of available lands. A display of available land for purchase can be displayed in the development map, see FIG. 4.

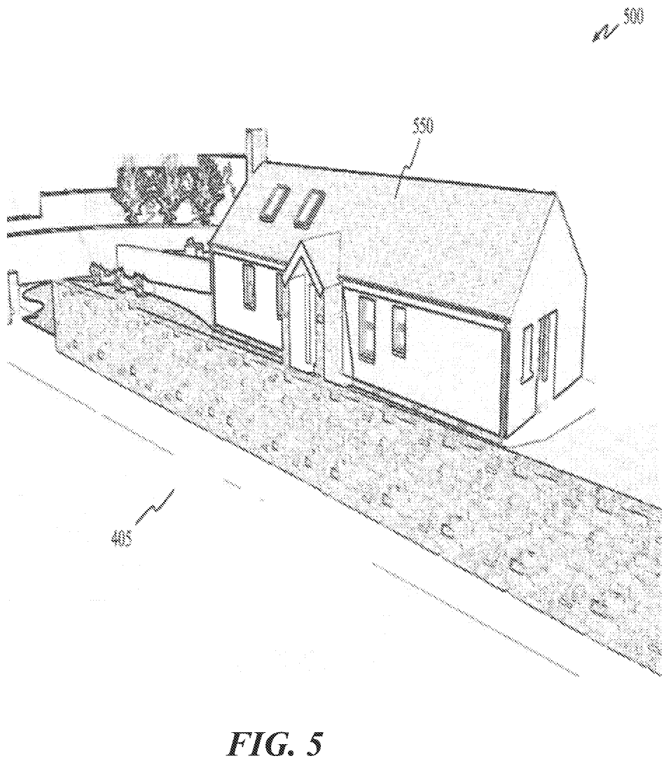

At 310, the buyer can select an available plot of land to investigate further. For example, a user may be provided with a selection and may be allowed to make the selection within a website or application implementing the systems and methods described herein. Referring to FIG. 4, the buyer can select lot 405 for example. At 315, the selected land is displayed to the user. System 300 can display an actual photo of the selected land in one portion of the display. System 300 can also display a rendered and detailed image of the plot of land that can include elevation contours, shape and size (to scale). For example, in one embodiment, renderings may be done using rendering software. In some embodiments, the rendering software may be integrated into the systems and methods described herein. In another example embodiment, renderings may be done using third party software. Examples of software that may be used for renderings include but are not limited to Autodesk Revit. Rendering software may utilize inputs of a home floorplan, land plot dimensions, and restrictions (e.g., such as setbacks, height, FAR). At 320, system 200 can also render the purchased (or any selected) modular home to scale onto the selected land (i.e., lot 405), see FIG. 5.

FIG. 5 illustrates a rendered image 500 of a purchased modular home 550 on lot 405. Rendering engine (not shown) of system 200 is configured to render modular home 550 and lot 405 to scale so that the buyer can accurately visualize how the purchased modular home would look on the selected lot. The rendering engine can also allow the buyer to add in features such as fences, trees, scrubs, or other features. The buyer can also select another lot (e.g., lot 410) and render the lot with modular home 550 to compare prior to purchasing any of the lots.

An aspect includes integrating into a partner metaverses. In such an aspect, the list of available modular homes may include a list of virtual modular homes. The first modular home may include a first virtual modular home. The available land may include available virtual land. The land may include virtual land. An aspect may include displaying available virtual land that fits one or more specifications set by a buyer of a virtual home. Another aspect may include creating a legal entity and one or more non-fungible tokens. Another aspect may include determining available lands for purchase based on at least one user preference. Another aspect may include rendering to scale the first modular home and an available land selected by the user.

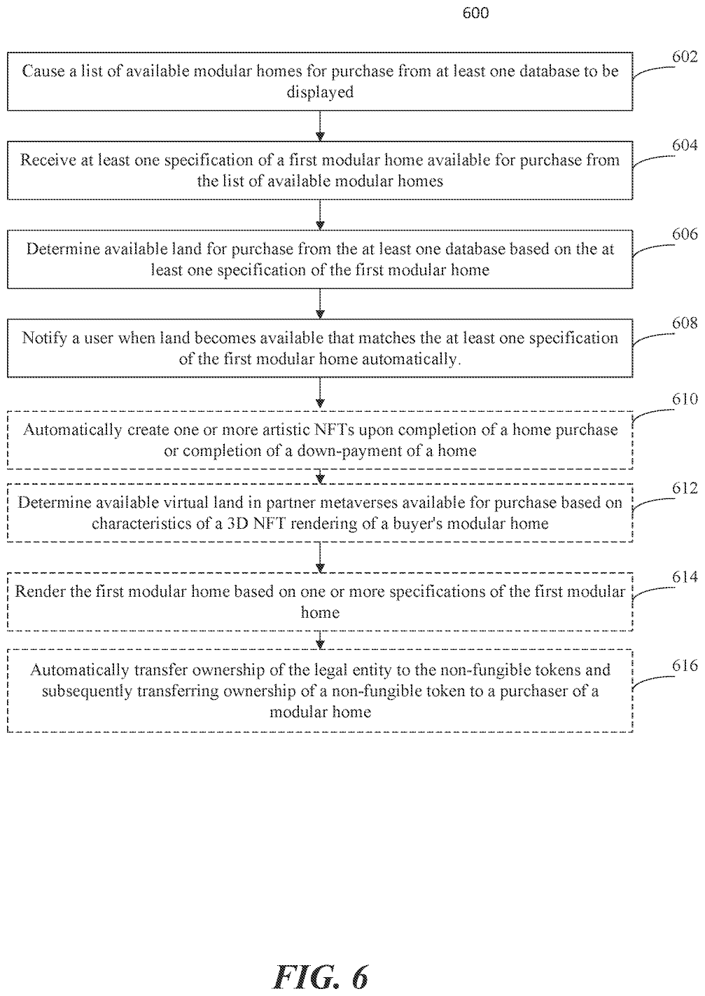

FIG. 6 is a flowchart of an aspect of a method for real estate transactions. The method for real estate transactions includes causing a list of available modular homes for purchase from at least one database to be displayed (602). The method for real estate transactions also includes receiving at least one specification of a first modular home available for purchase from the list of available modular homes (604). Additionally, the method for real estate transactions includes determining available land for purchase from the at least one database based on the at least one specification of the first modular home (606). The method for real estate transactions also includes notifying a user when land becomes available that matches the at least one specification of the first modular home automatically (608). Additionally, the method for real estate transactions optionally includes automatically creating one or more artistic non-fungible tokens (NFTs) upon completion of a home purchase or completion of a down-payment of a home (610). The method for real estate transactions also optionally includes determining available virtual land in partner metaverses available for purchase based on characteristics of a 3D NFT rendering of a buyer's modular home (612). Additionally, the method for real estate transactions optionally includes rendering the first modular home based on one or more specifications of the first modular home (614). The method for real estate transactions also optionally includes automatically transferring ownership of the legal entity to the non-fungible tokens and subsequently transferring ownership of a non-fungible token to a purchaser of a modular home.

As discussed above, the method for real estate transactions includes causing a list of available modular homes for purchase from at least one database to be displayed (602). Causing a list of available modular homes for purchase from at least one database to be displayed may include determining the list of available modular homes from the database, loading the list of available modular homes from the database, and displaying the list of available modular homes on one or more screens or devices.

As discussed above, the method for real estate transactions also includes receiving at least one specification of a first modular home available for purchase from the list of available modular homes (604). Receiving at least one specification of a first modular home available for purchase from the list of available modular homes may include receiving an input from a user indicating a specification of the modular home, storing the input from the user, and providing that input when needed to make determinations within the systems and methods described herein.

As discussed above, the method for real estate transactions includes determining available land for purchase from the at least one database based on the at least one specification of the first modular home (606). Determining available land for purchase from the at least one database based on the at least one specification of the first modular home may include determining land that is available for purchase in the database, comparing the land to the specification, and selecting land that meets the specification.

As discussed above, the method for real estate transactions also includes notifying a user when land becomes available that matches the at least one specification of the first modular home automatically (608). Notifying a user when land becomes available that matches the at least one specification of the first modular home automatically may include generating a message to a user based on a determination that land that meets the specification is available and transmitting the message to the user.

As discussed above, the method for real estate transactions optionally includes automatically creating one or more artistic non-fungible tokens (NFTs) upon completion of a home purchase or completion of a down-payment of a home (610). Automatically creating one or more artistic non-fungible tokens (NFTs) upon completion of a home purchase or completion of a down-payment of a home may include Determining that a home purchase or a down payment has occurred and issuing NFTs based on the determination.

As discussed above, the method for real estate transactions also optionally includes determining available virtual land in partner metaverses available for purchase based on characteristics of a 3D NFT rendering of a buyer's modular home (612). Determining available virtual land in partner metaverses available for purchase based on characteristics of a 3D NFT rendering of a buyer's modular home may include processing a list of virtual land and determining any land that is available and meets the characteristics.

As discussed above, the method for real estate transactions optionally includes rendering the first modular home based on one or more specifications of the first modular home (614). Rendering the first modular home based on one or more specifications of the first modular home may include loading the specifications and generating a drawing based on the specifications.

As discussed above, the method for real estate transactions also optionally includes automatically transferring ownership of the legal entity to the non-fungible tokens and subsequently transferring ownership of a non-fungible token to a purchaser of a modular home. Automatically transferring ownership of the legal entity to the non-fungible tokens and subsequently transferring ownership of a non-fungible token to a purchaser of a modular home may include performing any steps needed to transfer ownership of the legal entity to the non-fungible tokens automatically upon the occurrence of a predetermined event and performing any steps necessary to transfer the non-fungible tokens to the purchaser of the modular home.

The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described above are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

In the foregoing description and in the figures, like elements are identified with like reference numerals. The use of “e.g.,” “etc,” and “or” indicates non-exclusive alternatives without limitation, unless otherwise noted. The use of “including” or “includes” means “including, but not limited to,” or “includes, but not limited to,” unless otherwise noted.

As used above, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, processes, operations, values, and the like.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A system for real estate transactions, the system comprising:
at least one database;
a sales module configured to:
cause to be displayed a list of available modular homes for purchase from the at least one database,
receive at least one specification of a first modular home available for purchase from the list of available modular homes,
determine available land for purchase from the at least one database based on the at least one specification of the first modular home; and
a notification module configured to automatically notify a user when land becomes available that matches the at least one specification of the first modular home.

2. The system of claim 1, further comprising automatically creating one or more artistic non-fungible tokens (NFTs) upon completion of a home purchase or completion of a down-payment of a home.

3. The system of claim 1, further comprising integrating the system into a partner metaverses, wherein the list of available modular homes comprises a list of virtual modular homes, the first modular home comprises a first virtual modular home, the available land comprises available virtual land, the land comprises virtual land, and wherein the system is further configured to displaying available virtual land that fits one or more specifications set by a buyer of a virtual home.

4. The system of claim 3, wherein the sales module is further configured to determine available virtual land in partner metaverses available for purchase based on characteristics of a 3D NFT rendering of a buyer's modular home.

5. The system of claim 4, further comprising a rendering module configured to render the first modular home based on one or more specifications of the first modular home.

6. The system of claim 5, wherein a 3D rendering of a home informed by data processed by the rendering module is minted into an NFT.

7. The system of claim 1, further configured to create a legal entity and one or more non-fungible tokens.

8. The system of claim 7, further configured to automatically transfers ownership of the legal entity to the non-fungible tokens and subsequently transfers ownership of a non-fungible token to a purchaser of a modular home.

9. The system of claim 1, wherein the sales module is further configured to determine available lands for purchase based on at least one user preference.

10. The system of claim 1, further comprising a rendering module configured to render to scale the first modular home and an available land selected by the user.

11. A method for real estate transactions, the method comprising:
causing a list of available modular homes for purchase from at least one database to be displayed;
receiving at least one specification of a first modular home available for purchase from the list of available modular homes;
determining available land for purchase from the at least one database based on the at least one specification of the first modular home; and
notifying a user when land becomes available that matches the at least one specification of the first modular home automatically.

12. The method of claim 11, further comprising automatically creating one or more artistic non-fungible tokens (NFTs) upon completion of a home purchase or completion of a down-payment of a home.

13. The method of claim 11, further comprising integrating the method into a partner metaverses, wherein the list of available modular homes comprises a list of virtual modular homes, the first modular home comprises a first virtual modular home, the available land comprises available virtual land, the land comprises virtual land, and wherein the method is further configured to displaying available virtual land that fits one or more specifications set by a buyer of a virtual home.

14. The method of claim 13, further comprising determining available virtual land in partner metaverses available for purchase based on characteristics of a 3D NFT rendering of a buyer's modular home.

15. The method of claim 14, further comprising rendering the first modular home based on one or more specifications of the first modular home.

16. The method of claim 11, further comprising creating a legal entity and one or more non-fungible tokens.

17. The method of claim 16, further comprising automatically transferring ownership of the legal entity to the non-fungible tokens and subsequently transferring ownership of a non-fungible token to a purchaser of a modular home.

18. The method of claim 11, further comprising determining available lands for purchase based on at least one user preference.

19. The method of claim 11, further comprising rendering to scale the first modular home and an available land selected by the user.

20. A computer program product for real estate transactions, comprising: a non-transitory computer-readable medium comprising code for:
causing a list of available modular homes for purchase from at least one database to be displayed;
receiving at least one specification of a first modular home available for purchase from the list of available modular homes;
determining available land for purchase from the at least one database based on the at least one specification of the first modular home; and
notifying a user when land becomes available that matches the at least one specification of the first modular home automatically.
